(19) United States
(12) Patent Application Publication
(10) Pub. No.: US 2014/0101767 A1
(43) Pub. Date: Apr. 10, 2014

(54) SYSTEMS AND METHODS FOR TESTING AND MANAGING DEFENSIVE NETWORK DEVICES

(71) Applicants: Matthew Cohen, Irvine, CA (US); Andrew Tisdale, Huntington Beach, CA (US); Dan Kuykendall, La Mirada, CA (US)

(72) Inventors: Matthew Cohen, Irvine, CA (US); Andrew Tisdale, Huntington Beach, CA (US); Dan Kuykendall, La Mirada, CA (US)

(21) Appl. No.: 13/649,047

(22) Filed: Oct. 10, 2012

(51) Int. Cl. H04L 29/06

(52) U.S. Cl. CPC H04L 63/1433
USPC 726/25

(57) ABSTRACT

The field of the invention relates to systems and methods for securing networked computing devices, and more particularly to systems and methods for testing and managing defensive network systems. In a preferred embodiment, a defensive network management subsystem is included. The subsystem is operatively coupled to a defensive network system and a networked computing system. The defensive network management subsystem is configured to generate test data for the networked computing system, transmit the generated test data to the networked computing system, and record the networked computing system's response to the generated test data. The subsystem is further configured to correlate its recorded data with the defensive network system's response to said generated test data to assess the defensive network system's efficacy.

### FIELD OF THE INVENTION

The field of the invention relates to systems and methods for securing networked computing devices, and more particularly to systems and methods for testing and managing defensive network devices.

### BACKGROUND OF THE INVENTION

Placing a computing device on a public computer network, such as the Internet, subjects the computing device to considerable risk of unauthorized access and misuse by other entities. This is particularly true for server systems (such as websites on the Internet) that receive large amounts of data traffic, many of which come from unknown or anonymous sources. One approach known in the art to minimize this risk is the utilization of defensive network devices 300 (“DNDs”), shown in FIG. 1. These devices 300 are located such that they can inspect the data traffic going to and from a particular networked 200 computing device 100 for bad data traffic, e.g., data traffic that includes viruses or malware that may cause undesirable behavior to the networked computing device 100 and/or other devices that the networked computing device is operatively coupled to.

Traditional examples of DNDs known in the art include intrusion detection systems (“IDSs”), intrusion prevention systems (“IPS”) and web application firewalls (“WAFs”). These devices generally monitor data traffic on a network 200 going to and from a networked computing device 100 for bad traffic to alert personnel of detected bad traffic (“detection mode”) and/or automatically intercept and block such traffic (“prevention mode”).

The effectiveness of DNDs is generally dictated by their accuracy and precision, e.g., the ability to accurately and precisely discern bad traffic from good. Inaccurate DNDs can significantly impact businesses. For instance, failing to detect bad traffic may allow malware to enter into and infect a networked computing device 100 or it may allow an attack against the networked computing device 100 that will allow a hacker to take control of that device 100 or steal confidential data form that device 100. Further, genuinely good traffic inaccurately identified as bad may be blocked from the networked computing device 100, e.g., a genuine business transaction with a commercial website. Vendors of DNDs 300 can provide users with a large number of new rules on a regular basis, and it is very difficult for users of DNDs 300 to determine if these new rules will cause false positives in their network. False positives can have a high business cost because they can impair network traffic that a) is essential to the operation of the business and/or b) generates revenue. This may cause personnel to use DNDs in detection mode rather than prevention mode, thereby causing human intervention, which can slow response time and potentially overwhelm human resources.

This issue may be particularly prevalent in web applications. Because web applications are generally structured differently from one another and because they have different page and parameter names, traffic having undesirable attacks can be different from web application to web application. As such, a single solution attempt to apply to all web applications may likely cause accuracy issues and pose a significant risk of blocking good traffic. This risk can be dealt with by retesting a web application manually with good traffic but this is time consuming, especially given the large number of potential inputs in even a medium-sized web application. For example, studies have shown that with the current state of the art, it may take months for administrators and developers to test, detect and remedy vulnerabilities in a web application.

Accordingly, improved systems and methods for monitoring and managing defensive network devices are desirable.

### SUMMARY OF THE INVENTION

The field of the invention relates to systems and methods for securing networked computing devices, and more particularly to systems and methods for testing and managing defensive network systems

In a preferred embodiment, a defensive network management subsystem is included. The subsystem is operatively coupled to a defensive network system and a networked computing system. The defensive network management subsystem is configured to generate test data for the networked computing system, transmit the generated test data to the networked computing system, and record the networked computing system's response to the generated test data. The subsystem is further configured to correlate its recorded data with the defensive network system's response to said generated test data to assess the defensive network system's efficacy.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

In order to better appreciate how the above-recited and other advantages and objects of the inventions are obtained, a more particular description of the embodiments briefly described above will be rendered by reference to specific embodiments thereof, which are illustrated in the accompanying drawings. It should be noted that the components in the figures are not necessarily to scale, emphasis instead being placed upon illustrating the principles of the invention. Moreover, in the figures, like reference numerals designate corresponding parts throughout the different views. However, like parts do not always have like reference numerals. Moreover, all illustrations are intended to convey concepts, where relative sizes, shapes and other detailed attributes may be illustrated schematically rather than literally or precisely.

FIG. 1 is an exemplary diagram of a prior art networked computing system having a defensive network device;

FIG. 2 is an exemplary diagram of a system in accordance with a preferred embodiment of the present invention;

FIG. 3 is an exemplary diagram of a process in accordance with a preferred embodiment of the present invention.

FIG. 4 is an exemplary diagram of another system in accordance with a preferred embodiment of the present invention;

FIG. 5 is an exemplary set of network data generated by a system in accordance with a preferred embodiment of the present invention.

FIG. 6 is an exemplary report generated by a system in accordance with a preferred embodiment of the present invention.

FIG. 7 is an exemplary rule generated by a system in accordance with a preferred embodiment of the present invention.

FIG. 8 is an exemplary rule generated by a system in accordance with a preferred embodiment of the present invention.

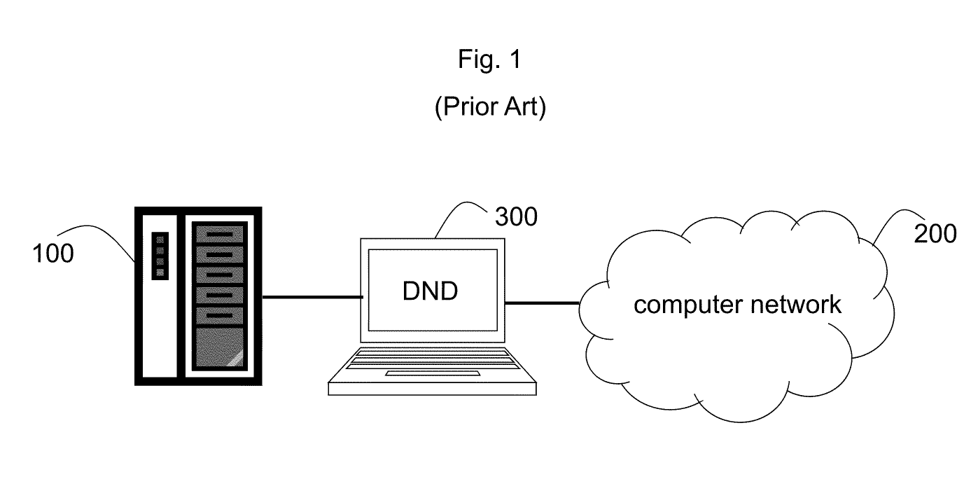

### DETAILED DESCRIPTION OF THE PREFERRED EMBODIMENTS

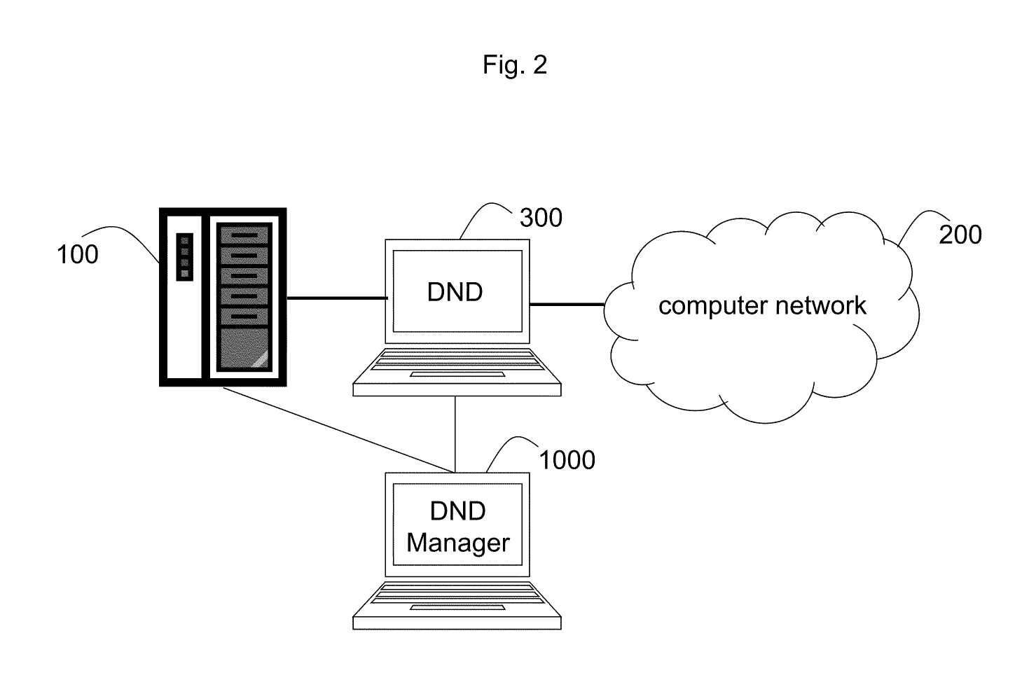

Turning to FIG. 2, a system is shown in accordance with a preferred embodiment of the present invention. In addition to a DND 300 known in the art, to address the issues described above, a DND management device 1000 is provided. The DND management device 1000 includes a processor, memory, a user interface, and a network component (not shown) operatively coupled to the DND 300 and the networked computing device 100. This coupling can be achieved by computer network 200, a separate network, and/or a direct connection. In the alternative, the DND management device 1000 can also be implemented as a software-based system included in the same physical device as the DND 300 or the networked computing device 100. The management device 1000 can also be operated on a separate server, remote to the DND 300 and the networked 200 computing device 100 in the form of a third party service, also known in the art as software as a service (“SaaS”).

Generally, the DND manager 1000 is configured to test and manage the DND 300 to ensure that the DND 300 is detecting bad traffic associated with the networked computing device 100 at a desirable level of accuracy, thereby facilitating a desirable level of operation by the networked computing device 100.

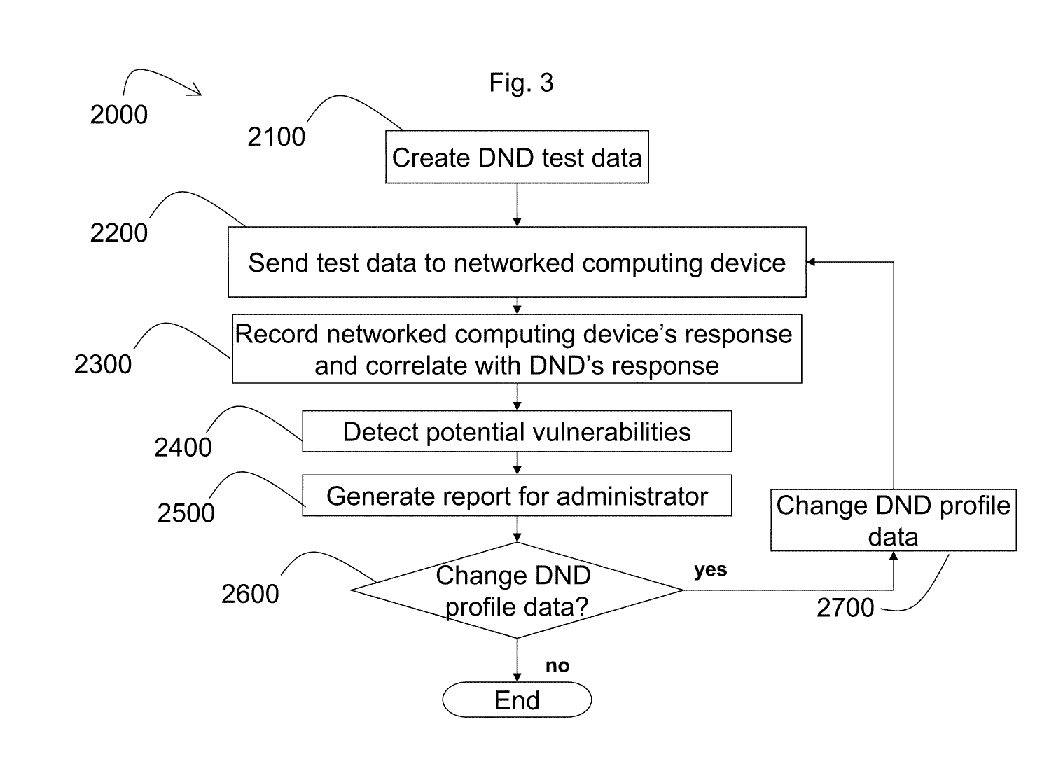

Turning to FIG. 3, a test and management process 2000 performed by the DND manager 1000 in accordance with a preferred embodiment of the present invention is shown. A test environment is first created with sample DND test data having both good and bad data traffic (Action Block 2100). This test environment can be generated in a number of ways by themselves or in combination. Below are some examples that can be used by themselves or in combination in accordance with a preferred embodiment:

1) The test data can be created manually by personnel. Packets can be created by hand or by creating network requests that are captured using a software program such as a proxy device (not shown) located between the DND 300 and the network computing device 100.

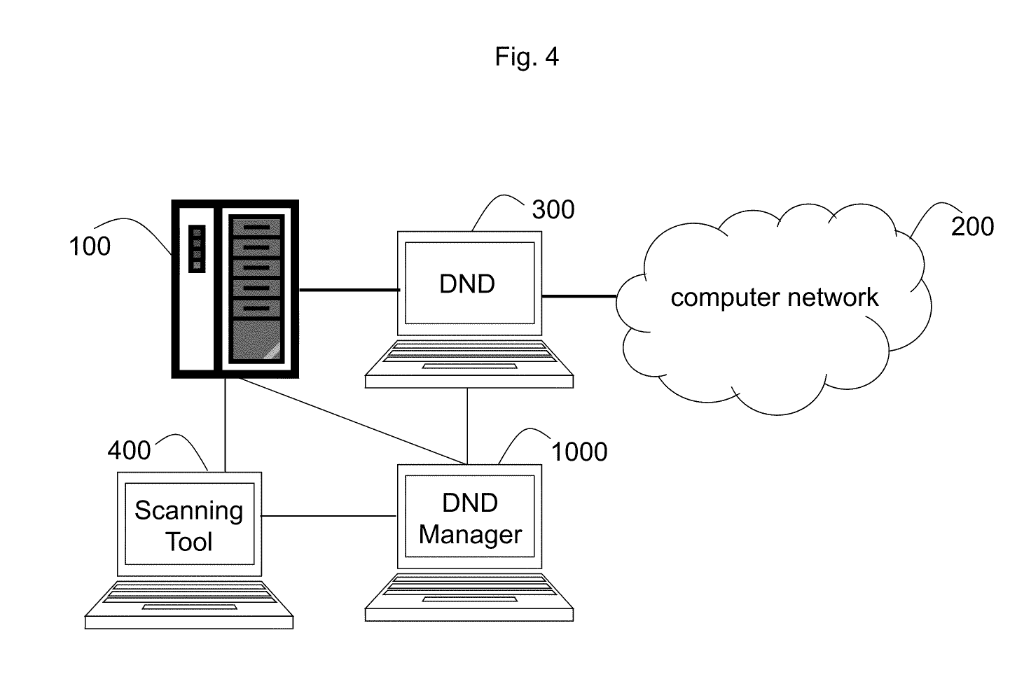

2) Turning to FIG. 4, an automated scanning tool 400 known in the art can be used to scan the computing device 100 to identify relevant weakness on the device through the use of pre-existing testing methods. In the case of web-based applications, a web application scanner such as NT OBJECTives NTOSpider can be used to create these requests (information of which can be found at http://www.ntobjective.com/security-software/ntospider-application-security-scanner/). A web application scanner 400 is generally configured to identify page(s) in a website and create a list of pages and parameters. For instance, scanning tool 400 can identify variable names and types, such as standard GET & POST parameters, or data inside JavaScript Object Notation (“JSON”), Representational State Transfer (“REST”), Action Message Format

(“AMF”), and Simple Object Access Protocol (“SOAP”) data formats. The page and parameter name combinations (with types) can be used to create the test data (Action Block 2100). This can be achieved by either recording actual packets or by placing the page data in a database and reconstructing the packets. For example, if there is a last name parameter on the home page of a site, the test data could include tests for O'Neil, Johnson and de Villas. These requests may be normal traffic that contains elements that can also be used in attacks (e.g. the words or, like, and, and delete which are used in many attacks or which is used in the name O'Neil, for example). This list can be expanded by extrapolating and creating additional requests to cover any potential gaps by the scanner. Such requests may include characters and strings to create a working attack payload and may incorporate known techniques for attacking websites, e.g., a SQL Injection attack.

To illustrate, a website (e.g., networked computing device 100) may sell a product, such as a handbag. On the page, the handbag may be associated with an ID number, e.g, 5. In normal operation, if a user selects the handbag, a request would be sent to the server 100 that would look as follows: http//www.site.com/viewproduct.php?id=5. The website would then forward the request to a backend database server to retrieve data associated with the product (not shown). To attack such a site, an example sequence of requests may look as follows:
A) http://www.site.com/viewproduct.php?id=5
B) http://www. site. com/viewproduct.php?id=7-2
   If the website's response to requests A) & B) match, it is likely that the backend database server to the website performed the calculation of 7-2 into 5 and then used that resulting number in its database lookup. An application with proper input escaping or a DND 300 with a proper rule or filter would not allow such a result. For example, the rule in the DND 300 would include blocking the use of the minus sign. A scanning tool 400 would be used to create data, such as the second request, that would facilitate detecting whether such a rule exists within the DND 300.

In yet another example, DNDs 300 known in the art will typically detect and block a known SQL Injection attack known as ‘or 1=1’. The request may look like the following: http:/www.webscantest.com/login.php?user=admin' or 1=1&password=Password1. Typical DNDs 300 would include rules to block such known attacks. However, more sophisticated attacks may use variations not detectable by these typical rules. For instance, an attack may change (admin' OR 1=1) to (admin' OR MOD(8,7) IN (1)), where MOD (8,7) is a math operation remainder and IN(1) is asking if 1 is in a list where the only value in the list is 1. The end result is effectively the same ‘or 1=1’ SQL Injection attack but may be undetectable with existing DNDs 300. The scanning tool 400 may be used to create and test these variations to identify whether a DND 300 has a rule or filter to block such attacks.

3) A device, such as a sniffer known in the art, can be placed in front of the networked computing device 100 and record normal network traffic to create the test data (Action Block 2100). Further, this device can be placed in front an entire network or any subset thereof by specifying a subnet, IP range, or individual devices. This normal network traffic could be used to configure the DND 300 to assess whether the rules are too broad, thereby undesirably blocking good traffic. For example, one rule may block the unexpected use of However, there may be situations where the use of ' is proper. For instance: http://www.webscantest.com/datastore/search_get_by_lastname.php?name=O'Brian. Normal network traffic with data such as this may facilitate in determining whether the DND 300 improperly blocks an otherwise proper request (i.e., good data). For example, for phone numbers, numbers plus ( )-.[space] must be allowed, and for email addresses, alphanumeric plus @.-_must be allowed. A DND 300 configured after being tested with such data from an intranet or subnet may provide the administrator a high degree of confidence that the particular intranet is free of malicious traffic and could use all the traffic from that subnet.

4) Vendors and/or IT professionals can supply test data for specific networked computing device 100. For example, a payroll web application vendor could supply good test data to be used to test their software.

5) Vendors can supply log files from their defensive network devices 300 that are a) on network segments assumed to have only good data or b) scrubbed of malicious requests by their device to generate good test data.

6) Protocol specific templates can be used to aid in the creation of requests with support for replaceable values. For example, in the case of a POP3 email checking protocol, the data exchange may look as follows:
SEND: USER [email|username]
SEND: PASS [password]
RECV: OK+
SEND: STAT
RECV: OK+
SEND: LIST
RECV: 1 1205
RECV: 2 1206
SEND: RETR [int]
SEND: TOP [int]
SEND: QUIT
   With this template, DND test data can be generated from modifying certain aspects of this protocol with possible attack data.

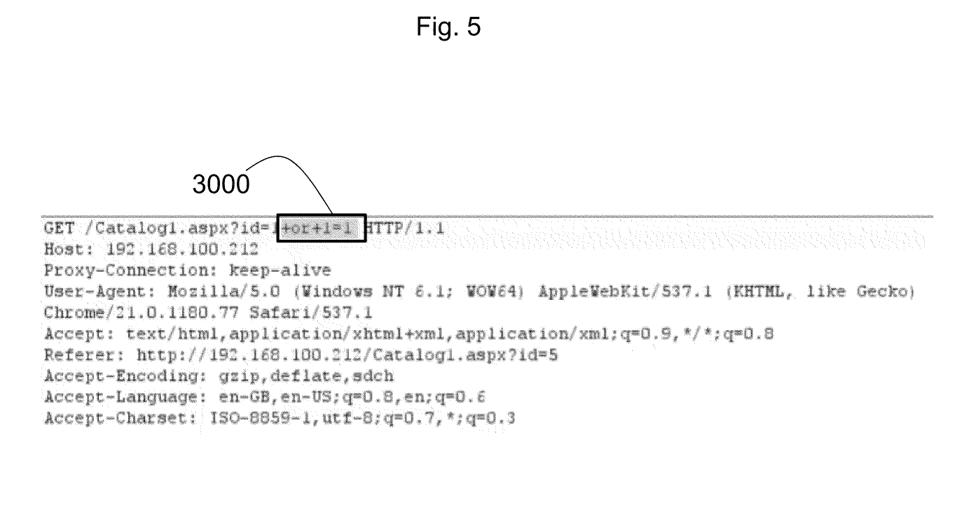

After the test data and environment has been established (Action block 2100), the test data is provided to the DND manager 1000, which then applies the test data to the networked computing device 100 (Action Block 2200). It will create test packets and/or requests from the test data and transmit them over the network 200 to the networked computing device 100 and the DND 300. The DND manager 1000 will then record the networked computing device's 100 responses (Action Block 2300). The DND manager 1000 can also access the DND's 300 logs that will record its responses to the test data sent to the networked computing device 100. Preferably, the DND 300 is configured to be in detection mode so that the DND 300 will identify the traffic it determines is bad based on its current configuration. The DND manager 1000 can then correlate the networked computing device's 100 response with the data in the DND's 300 log to determine which packets/requests are deemed bad by the DND 300 and assess what blocked data will look like (Action Block 2300). Turning to FIG. 5, an example result of a correlation is shown, illustrating where the ‘or 1=1’ SQL Injection attack 3000 is detected by the DND manager 1000 and/or DND 300.

From the correlation at Action Block 2300, the DND manager 1000 can facilitate the detection of potential vulnerabilities with the DND 300 (Action Block 2400). For example, the DND manager 1000 can determine whether the DND 300 is failing to capture certain bad traffic by testing the DND 300 with a series of traffic requests that are known to be malicious and measuring the responses of the DND 300. In another example, the DND manager 1000 can have an interface that allows users to specify the bad traffic response of the DND 300. In yet another example, the DND manager 1000 can be configured with known bad traffic responses of DNDs 300 that it can check to see if a response indicates bad traffic. Further, the DND manager 1000 can determine the DND 300 used based on a response to bad traffic or by allowing the user to select the DND 300 in use.

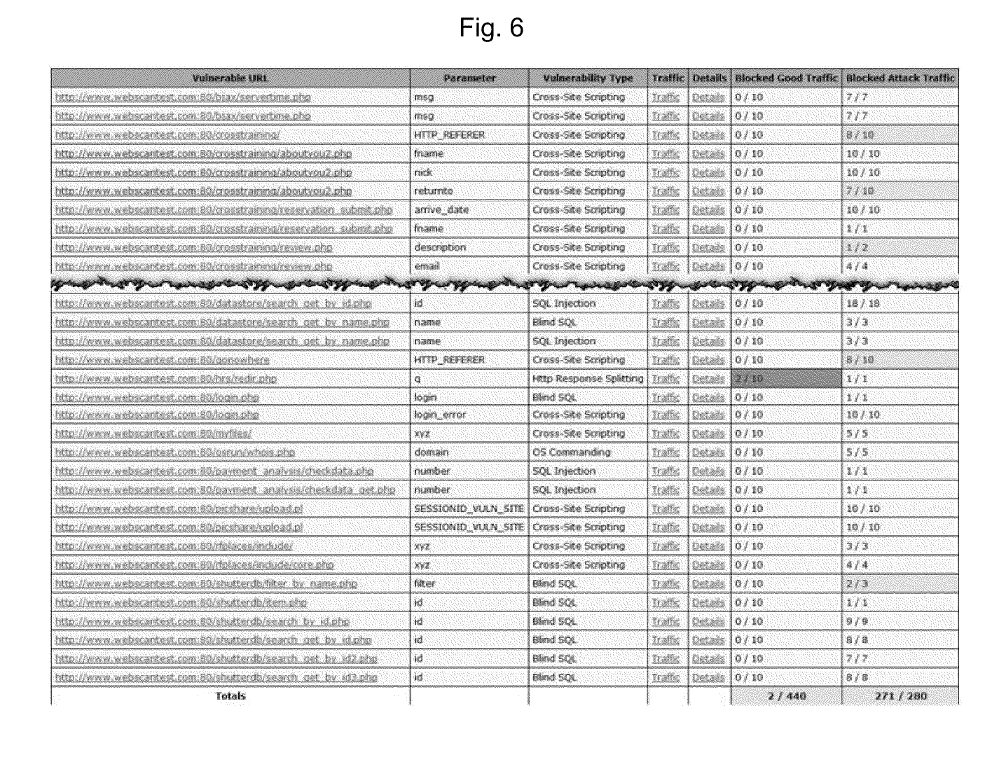

The DND manager 1000 can then generate a report that presents the results of the correlation to an administrator (Action Block 2500). An example report is shown in FIG. 6. The report may include the following information:

1) A summary grouped by packet/request type with number of requests assumed to be good traffic and the number that were blocked. For web applications, for example, this can include requests grouped by page and/or parameter type.

2) The response to each request.

3) In the case where the test data was generated from normal traffic, e.g., with a web scanning application 400, there may be an increased possibility that some of the requests will be bad traffic, such as attacks. In this case, false positives should not be reported and if there are a large number of these, weeding out these results will be time consuming. The following methods can be implemented to deal with this problem:

a. Certain IP addresses or subnets (for example, an internal IP range) can be assumed to be free of attacks (by input from trusted personnel, such as IT professionals), and their results can be prioritized. Certain IP addresses or subnets can be blacklisted, illustrating that their results are less likely to be trusted and should be deprioritized.

b. The DND manager 1000 can learn which addresses are likely to have a low percentage of attacks and prioritize the results from these addresses. The default thresholds for what to display or not display in the results from a particular source can be changed by the user.

c. IT personnel can confirm whether a request is an attack or good traffic. This can be stored permanently so there will be no errors in future scans.

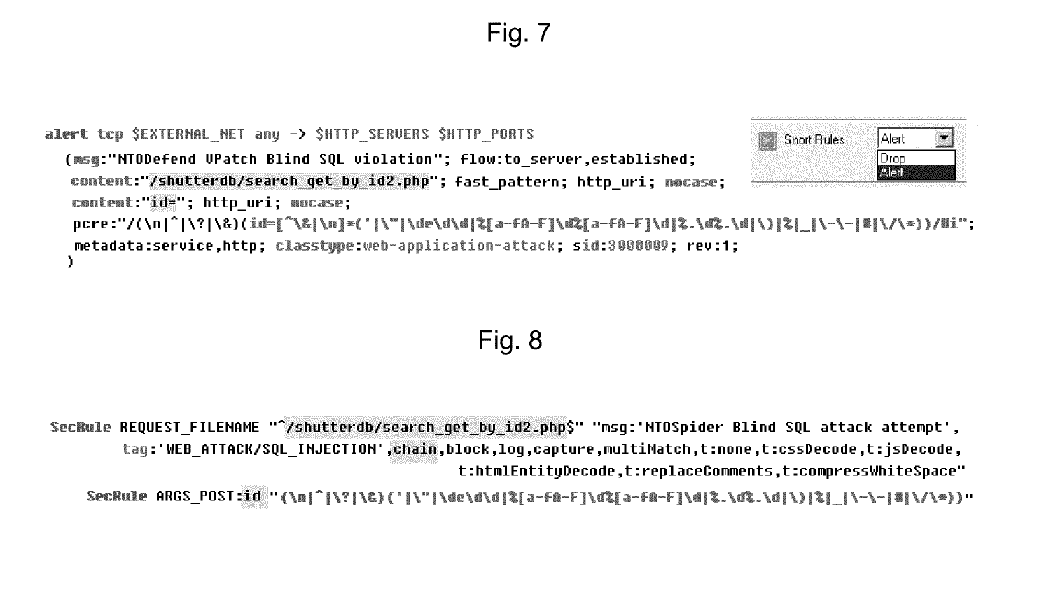

In many cases, particularly commercial web applications, the networked computing device 100 undergoes constant changes and modifications, whether it is hardware and/or software upgrades and/or modifications. In the case of web applications, changes are constantly made to the web page, including certain parameters that could affect the ability to accurately detect good and bad data traffic. When such changes are made, changes generally need to be made to the DND 300, e.g., its rules and filters, to account for this, which may affect accuracy even after the proper changes were made. The data and rules that define how the DND 300 detects good and bad data are generally stored as profiles in a DND 300 database (not shown). In a preferred embodiment, if changes to a DND 300 profile are warranted, e.g., existing rules fail to detect certain bad traffic types or block certain good traffic types (Decision Block 2600), then the DND 300 profile changes are made and uploaded back to the DND 300 (Action Block 2700). Through Action Blocks 2100-2400, the DND manager 1000 gains specific knowledge of working attack payloads and vulnerabilities specific to the network computing device 100. Preferably, the DND manager 1000 includes a library of rule modifications to address the specific attack payloads and vulnerabilities. This enables the DND manager 1000 to automatically create a custom set of improved, more aggressive, rules to detect and block sophisticated attacks not captured by the generic rules of existing DNDs 300. Moreover, these custom rules may be combined with the pre-existing generic set. Further, specific knowledge of expected good traffic is also gained, thereby enabling the DND manager 1000 to improve the rules that pass through good traffic as well. Example improved rules may include block single and/or double quotes, block parenthesis, block non-ANSI characters, and block letters or numbers as appropriate. Additional example rules generated by the DND manager 1000 in accordance with a preferred embodiment are shown in FIGS. 7 and 8. FIG. 7 illustrates a rule generated for a Snort DND system 300 from Sourcefire. FIG. 8 illustrates a rule generated for a ModSecurity DND system 300. After the DND profile change (Action Block 2700), the DND manager 1000 will then repeat the testing process in 2000 described above beginning at Action Block 2200. Preferably, the testing process in 2000 is repeated with both good and bad traffic. A subsequent report may then be generated at Action Block 2500 that reflects the results of the modified rules to assess whether the modified DND 300 rules have improved performance, e.g., whether the DND rules are effective at blocking specific attacks or series of attacks and whether additional good data have been passed through compared to the previous rules.

For Action Block 2500, in the case where the networked computing device 100 is a web application and a change to the DND profile was made, the report can provide data and screen captures of the traffic before and after any change is made to the DND profile data.

The systems and methods described herein will substantially reduce the time required to test and configure DNDs 300 before new blocking rules are implemented to allow them to be in prevention or blocking mode much more frequently, thereby contributing to a more effective security posture. Further, remediation of detected vulnerabilities can be achieved without modifying the network computing device's 100 source code.

In the foregoing specification, the invention has been described with reference to specific embodiments thereof. It will, however, be evident that various modifications and changes may be made thereto without departing from the broader spirit and scope of the invention. For example, the reader is to understand that the specific ordering and combination of process actions described herein is merely illustrative, and the invention may appropriately be performed using different or additional process actions, or a different combination or ordering of process actions. For example, this invention is particularly suited for web-based/Internet/Intranet network security systems; however, the invention can be used for any network security system in general. Additionally and obviously, features may be added or subtracted as desired.

Accordingly, the invention is not to be restricted except in light of the attached claims and their equivalents.

What is claimed is:

1. A computer system for managing a defensive network system associated with a networked computing system, said computer system comprising:
a defensive network management subsystem operatively coupled to the defensive network system and the networked computing system, wherein the defensive network management subsystem is configured to:
generate test data for the networked computing system;
transmit the generated test data to the networked computing system; and
record the networked computing system's response to the generated test data;
wherein the defensive network system generates response data that identifies whether the transmitted test data is undesirable, and
wherein the defensive network management subsystem is further configured to correlate its recorded data with the defensive network system's response data to assess vulnerabilities in the defensive network system.

2. The computer system of claim 1, wherein the defensive network management subsystem is further configured to generate a report that identifies data identified as bad traffic by the defensive network system to enable adjustment of the defensive network system.

3. The computer system of claim 1, wherein the networked computing system is a website, and the defensive network management subsystem includes a web scanning application to generate the test data for the website.

4. The computer system of claim 1, wherein the defensive network system includes an electronic profile of rules that define what network traffic is blocked by the defensive network system, and wherein the defensive network management subsystem is further configured to detect whether the defensive network system is blocking known bad traffic, and further configured to modify the rules of the electronic profile to block said known bad traffic if the defensive network management subsystem determines that the defensive network system is not blocking said known bad traffic under the current rules of the electronic profile.
